(19) United States
(12) Patent Application Publication
(10) Pub. No.: US 2025/0077592 A1
(43) Pub. Date: Mar. 6, 2025

(54) SYSTEMS AND METHODS FOR DYNAMIC DATA SELECTION

(71) Applicant: Meta Platforms, Inc., Menlo Park, CA (US)

(72) Inventors: Marianne Giesemann Epstein, Seattle, WA (US); Kirthanaa Raghuraman, Mountain View, CA (US)

(21) Appl. No.: 17/953,381

(22) Filed: Sep. 27, 2022

(51) Int. Cl. G06F 16/9535; G06F 16/951; G06Q 50/00; H04L 67/306; H04L 67/50

(52) U.S. Cl. CPC G06F 16/9535; G06F 16/951; G06Q 50/01; H04L 67/306; H04L 67/535

(57) ABSTRACT

Systems and methods for extracting data from digital messages for digital group compositions may include (1) determining that a user of a social networking platform, which provides multiple digital services to its users, has accessed a digital service of the social networking platform less than a threshold amount and (2) in response to determining that the user has accessed the digital service less than the threshold amount, presenting a selectable tile, which serves as an entry point for the digital service, in a digital tray of entry point tiles provided via a social media feed configured for the user. Various other methods, systems, and computer-readable media are also disclosed.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 is a flow diagram of an exemplary method for dynamic data selection.

FIG. 2 is a block diagram of an exemplary system for dynamic data selection.

FIG. 3 is an illustration of an exemplary newsfeed interface.

FIG. 4 is an illustration of an exemplary stories feed interface.

FIG. 5 is an illustration of an exemplary messaging interface.

FIG. 6 is an illustration of an exemplary short-form video feed interface.

FIGS. 7-9 are illustrations of exemplary social media feed interfaces with a digital tray of selectable entry point tiles.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

This application is directed to a system for dynamically selecting digital content for a top-of-feed digital tray within a social media feed interface (e.g., a newsfeed interface). Selection factors may include, for example, usage data, contact information, and predicted user utility. In one example, usage data indicating that a user does not use a particular digital service (e.g., a short-form video platform) may trigger the placement of a selectable tile that navigates to the particular digital service in the top-of-feed digital tray (e.g., to boost user engagement with the particular digital service). Usage data indicating that a user frequently uses a particular digital service (e.g., a stories platform) may also trigger the placement of a selectable tile that navigates to the particular digital service in the top-of-feed digital tray. In some examples, contact information may trigger the placement of a tile that navigates to a particular digital service in the top-of-feed tray. For example, a determination that a user does not have many contacts may trigger the placement of a tile for a digital service that presents primarily non-connected content (e.g., a short-form video service that primarily streams platform-recommended content). In some examples, a system (e.g., a machine learning system) may predict a utility derived from a social media platform by a user (e.g., catching up with friends and family, staying in the loop with news and interests, being entertained, and/or building community) and may select tiles for the top-of-feed digital tray that navigate to digital services that best align with the predicted utility. The disclosed top-of-feed content selection system may improve the functioning of a computer itself by improving the placement of digital content, data organization, and digital service navigation (e.g., by providing a dynamically selected service-navigation flow).

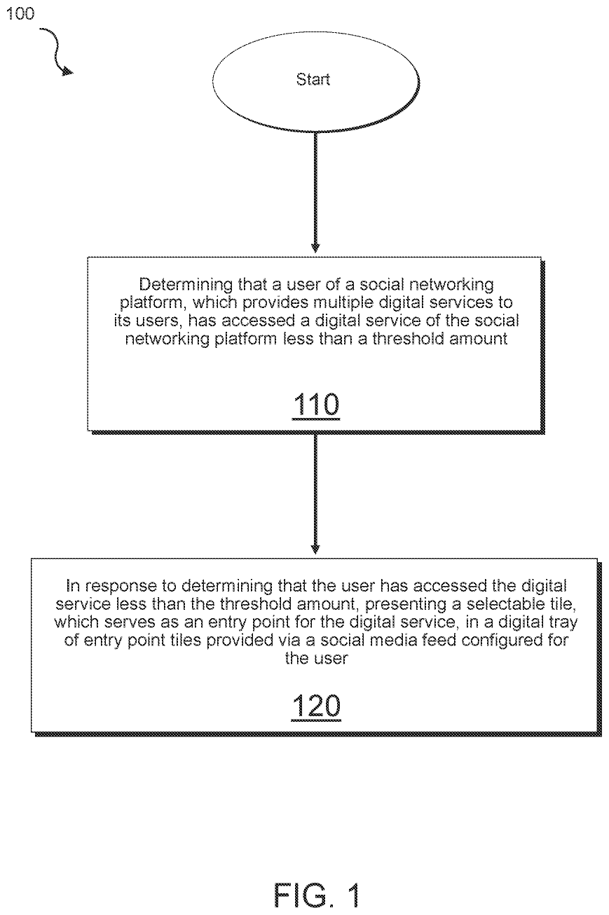

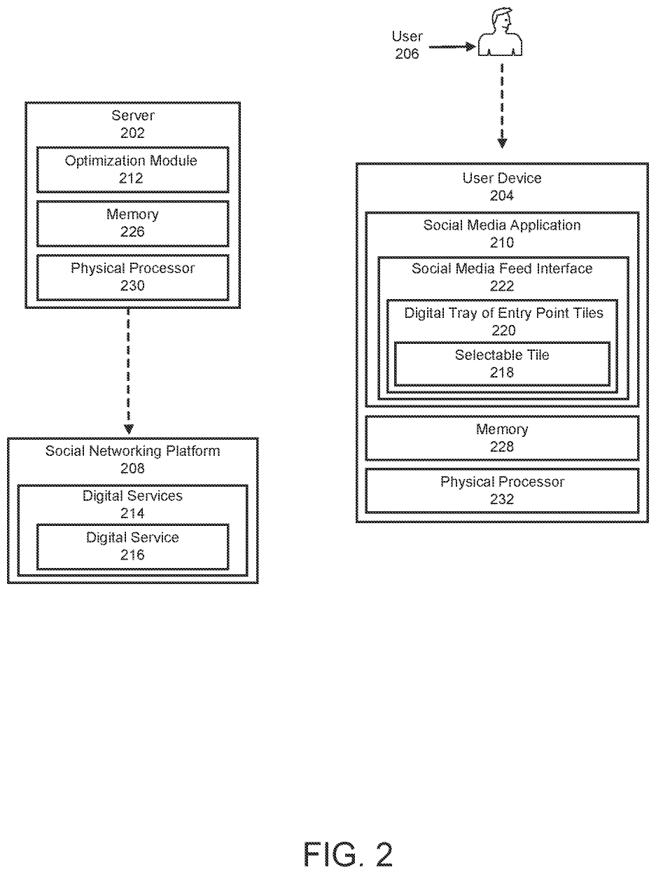

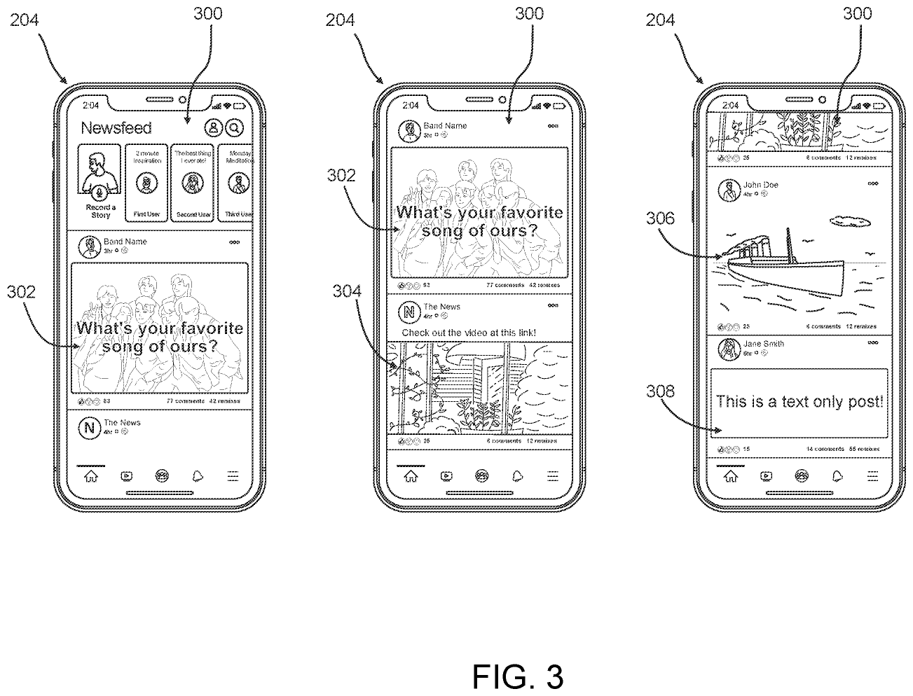

The following will provide, with reference to FIG. 1, detailed descriptions of computer-implemented methods for dynamic data selection (e.g., dynamic digital service entry point placement). Detailed descriptions of corresponding example systems will also be provided in connection with FIG. 2. In addition, detailed descriptions of corresponding user interfaces will be provided with FIGS. 3-9.

FIG. 1 is a flow diagram of an exemplary computer-implemented method 100 for dynamic data selection (e.g., dynamic digital service entry point placement). The steps shown in FIG. 1 may be performed by any suitable computer-executable code and/or computing system, such as the systems described herein. In one embodiment, the steps shown in FIG. 1 may be performed by modules operating within a computing device. For example, the steps shown in FIG. 1 may be performed by modules operating in a server 202 and/or modules operating in a user device 204 (associated with a user 206). In one example, each of the steps shown in FIG. 1 may represent an algorithm whose structure includes and/or is represented by multiple sub-steps, examples of which will be provided in greater detail below.

Server 202 generally represents any type or form of backend computing device that may perform one or more functions directed at social networking. The term “social networking” may refer to any type or form of digital communication that occurs between users of a platform via an interface of the platform (e.g., text-based communication, video conferencing and/or audio conferencing, digital status broadcasting, public content posting and/or commenting, etc.). In some examples, server 202 may operate as part of and/or in connection with a social networking platform 208. Although illustrated as a single entity in FIG. 2, server 202 may include and/or represent a group of multiple servers that operate in conjunction with one another.

User device 204 generally represents any type or form of computing device capable of reading computer-executable instructions. For example, user device 204 may represent a smart phone and/or a tablet. Additional examples of user device 204 may include, without limitation, a laptop, a desktop, a wearable device, a personal digital assistant (PDA), etc.

In some examples, user 206 of user device 204 may be a user (e.g., a member) of social networking platform 208. In these examples, user device 204 may have installed an instance of a social media application 210, which may operate as part of social networking platform 208 and through which one or more services provided by social networking platform 208 (e.g., via server 202) may be accessible. In some examples, social media application 210 may be dedicated to a single service. For example, social media application 210 may represent a dedicated newsfeed application. In other examples, social media application 210 may provide access to multiple services (e.g., a combination of the digital newsfeed service, digital story service, digital messaging service, and/or digital short-form video service described below). In addition, or as an alternative, to social media application 210, user device 204 may have installed a browser that may navigate to one or more webpages through which the one or more services provided by social networking platform 208 (e.g., via server 202) may also be accessible.

As mentioned above, social networking platform 208 may provide a variety of services (e.g., platforms and/or digital frameworks) for the users within its network (e.g., via server 202 and/or social media application 210). For example, social networking platform 208 may provide a newsfeed service. The term “newsfeed” may generally refer to any type or form of social media consumption channel that presents a scrollable collection of newsfeed posts. In some examples, a newsfeed may scroll (e.g., upward or downward) to reveal different posts within the newsfeed (e.g., in response to receiving user scrolling input). In one example, the scrollable collection may include newsfeed posts created by contacts of a particular user (e.g., friends of the particular user). In some examples, a particular user's newsfeed may be configured to include a combination of connected newsfeed posts (e.g., posts created by a contact of the particular user and/or by a user whom the particular user is following) and non-connected newsfeed posts (e.g., posts generated by users who are not contacts of the particular user and/or who are not being followed by the particular user). In some such examples, a newsfeed may be configured to include a determined ratio, or a ratio within a determined range of ratios, of connected to non-connected newsfeed posts (e.g., that favors connected posts).

The term “newsfeed post” generally refers to any type or form of digital composition that may be displayed in a newsfeed. Newsfeed posts may include, without limitation, text, an image, a video, a set of multiple images and/or videos, and/or a link (e.g., to a post, webpage, article, film, etc.). FIG. 3 depicts an exemplary newsfeed interface 300 with a newsfeed that includes a combination newsfeed post 302 with an image and text, a link-based newsfeed post 304, a video-based newsfeed post 306, and a text-based newsfeed post 308. In some examples, a newsfeed post may include a viewing pane for the content of the newsfeed post (e.g., the text in a text-based post, the image in an image-based post, etc.). A newsfeed post may also display a text-based caption, metadata content (e.g., content describing users that have been tagged in the newsfeed post, a timestamp, etc.), information indicating the source of the newsfeed post (e.g., the name of the creator of the post, a profile image, etc.), and/or a digital special effect (e.g., a digital sticker, a filter, an-augmented reality element, etc.). Such information and/or features may be displayed within the viewing pane (e.g., over the primary content), above the viewing pane, beneath the viewing pane, and/or may be otherwise visually associated with newsfeed post. The newsfeed service may enable viewers of a newsfeed post to respond to the newsfeed post in a variety of ways. In some examples, a newsfeed interface may enable a user to comment on a newsfeed post, via a text, image, and/or video-based reply, and may create a digital thread of comments corresponding to the newsfeed post (e.g., displayed beneath the newsfeed post and/or accessible via a comments affordance).

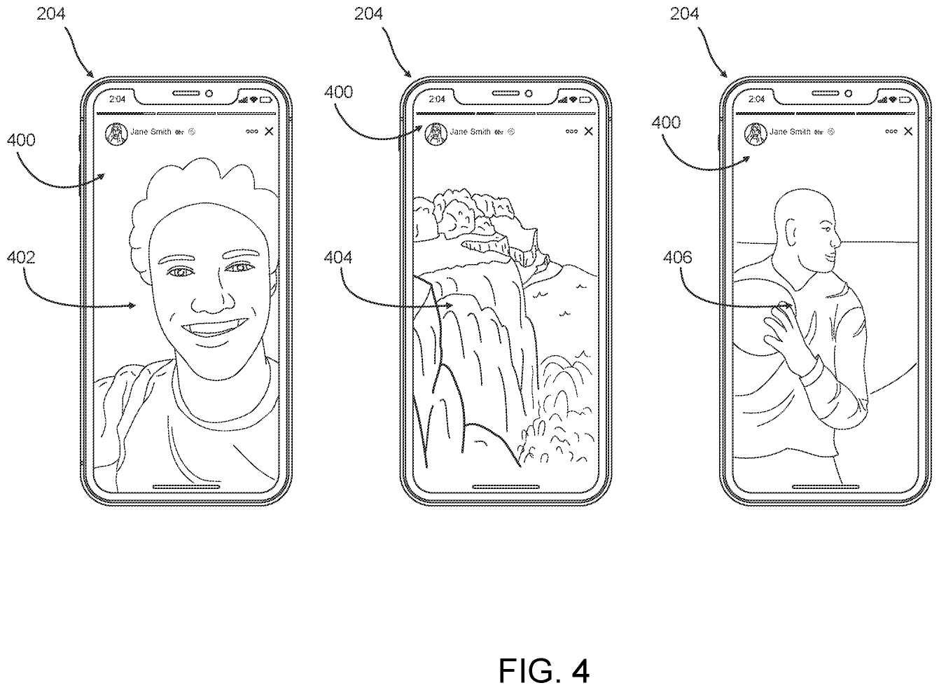

As another example, social networking platform 208 may provide a digital story service. The digital story service may provide users with a story consumption channel, which presents a continuous series of digital story posts to a story-consumer, one by one (e.g., in a slideshow format). The term “digital story post” may generally refer to any type or form of social media post intended for a story consumption channel. A digital story composition may include a variety of content (e.g., a digital photograph, a graphic, text, a digital video and/or a digital recording of a music composition). In one example, the story consumption channel may transition from presenting one digital story post to the next automatically, without requiring any user input to do so. In some examples, digital story posts from the same source (e.g., created and/or posted by the same user) may be grouped together within the story consumption channel, such that each digital story post from a particular source is displayed prior to displaying digital story posts from another source. In one embodiment, a digital story post may be ephemeral. That is, the digital story post may only be viewable for a predetermined amount of time. For example, a digital story composition may be set to disappear after twenty-four hours. FIG. 4 depicts an exemplary story interface 400 showing digital story posts 402, 404, and 406 of a user's digital story. Similar to the newsfeed service, the digital story service may enable viewers of a story post to comment on the post, via a text and/or image-based reply and/or reply story, creating a digital thread of comments. Similar to the newsfeed service, a stories service may configure a story feed for a particular user that includes connected content (e.g., story posts created by users who are contacts of the particular user or being followed by the particular user), non-connected content, or a determined ratio of connected content to non-connected content.

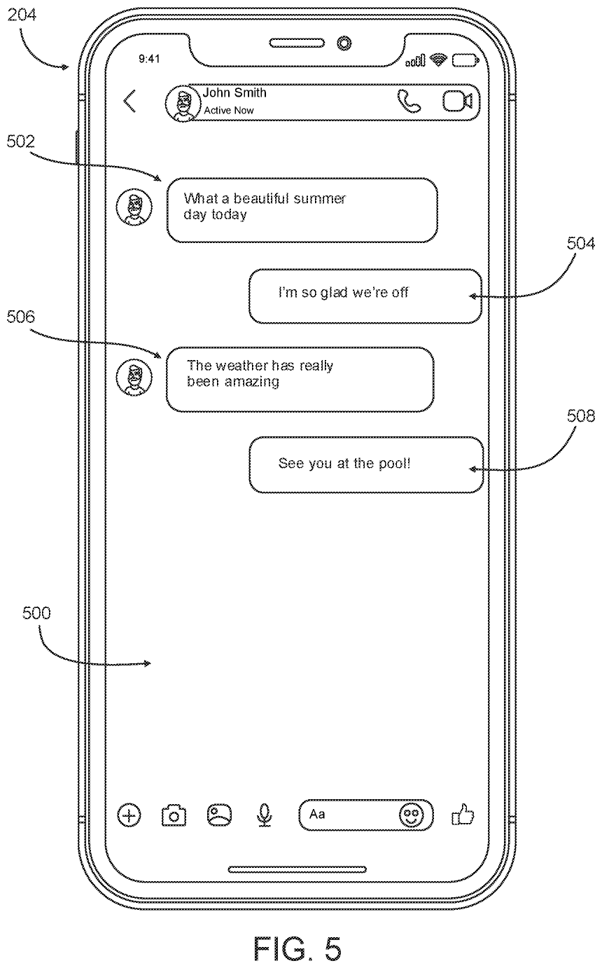

As another example, social networking platform 208 may provide a messaging service. The term “messaging service” may generally refer to any type or form of digital message delivery system that enables users of social networking platform 208 to exchange messages (e.g., text messages, audio messages, and/or video messages). FIG. 5 depicts an exemplary messaging interface 500 showing digital message posts 502, 504, 506, and 508 of a digital messaging thread.

In some examples, social networking platform 208 may provide a short-form video service (e.g., a reels service) that enables users to create short-form videos and/or consume (e.g., watch and/or digitally respond to) short-form videos created by other users. In one embodiment, social networking platform 208 may create a short-form video feed for each user of its short-form video service. The term “short-form video” may generally refer to a digital video configured for short-form video feed consumption. In some examples, a platform for creating and/or posting a short-form video may only enable the creation and/or posting of short-form videos that are a certain length and/or that are less than a certain length (e.g., thirty seconds or less in length).

The term “short-form video feed” may generally refer to a series (e.g., a queue) of short-form videos (e.g., selected for a particular user) that social media application 210 (or a corresponding webpage) is configured to play, one by one, as a continuous series (e.g., advancing from one short-form video to the next automatically). In some examples, a short-form video feed may be configured to play short-form videos asynchronously (e.g., to play a continuously evolving queue of pre-recorded short-form videos). In one embodiment, the short-form video feed may only be configured to play pre-recorded short-form videos. Additionally or alternatively, a short-form video feed may be configured to play live short-form videos. In some examples, short-form videos may be continuously added to a user's short-form video feed as the short-form videos of the feed are consumed (e.g., such that a determined number of short-form videos are always in queue to be played).

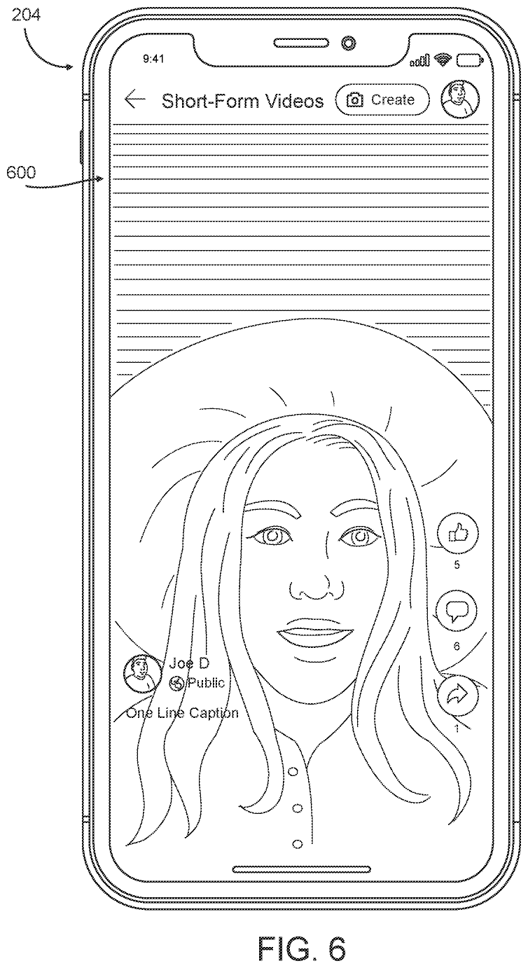

In some examples, a short-form video feed may be presented via a dedicated short-form video feed interface. In certain embodiments, short-form videos selected for a short-form video feed may be changed (and/or an order in which short-form videos are presented may be changed) each time the short-form video feed interface is refreshed. A short-form video feed interface may be refreshed in response to a variety of triggers (e.g., each time a user accesses the feed, each time the user digitally initiates a refresh action, in response to scrolling input, at designated intervals, etc.). FIG. 6 depicts an exemplary dedicated short-form video feed interface 600 presenting a short-form video. In some examples, as mentioned previously and as depicted in FIG. 6, short-form videos may be presented one by one as a continuous series of short-form videos (e.g., in a slideshow format). In other examples, multiple short-form videos may be displayed at once in a short-form video digest (e.g., via a full-screen digest of short-form video tiles, each corresponding to a different short-form video, or via a strip of short-form video tiles). In such examples, content from a short-form video may be configured to play in a loop within the short-form video's video tile. In some examples, a short-form video feed may be streamed via another platform of social networking platform 208. For example, a short-form video feed may be displayed via a short-form video strip in a newsfeed of a newsfeed service of social networking platform 208.

Short-form videos may be selected for the short-form video feed of a particular user based on a variety of metrics. For example, a short-form video may be selected based on a topic the short-form video has been tagged with in response to a determination that the particular user is interested in and/or predicted to be interested in the topic (e.g., based on usage history and/or demographic information submitted by the user). As another example, a short-form video may be selected based on a user who created the short-form video (e.g., in response to a determination that the particular user is following the user and/or is predicted to be interested in content posted by the creator). As another example, a short-form video may be selected based on a popularity of the short-form video.

In some examples, a short-form video feed may be thought of (e.g., configured) as a framework that exclusively and/or primarily provides users with non-connected content and/or that provides a user with a combination of non-connected content and content created by content-creators that the user is following. In contrast, a newsfeed and/or stories feed may be thought of (e.g., configured) as a framework that primarily provides its users with connected content or that provides users with a combination of connected and non-connected content. In some examples, a newsfeed and/or stories feed may be configured to include a determined ratio of connected to non-connected content in which connected content is favored over non-connected content (e.g., more connected content is included than non-connected content). By contrast, a short-form video feed may be configured to include only non-connected content or to include a determined ratio of non-connected content to content created by content-creators a particular user is following.

In some embodiments, a short-form video may be displayed (e.g., streamed) with a variety of information relating to the short-form video. Such information may include, for example, a name and/or profile element of an account that created the short-form video, a title of the short-form video, viewer responses to the short-form video and/or an affordance that navigates to viewer responses to the short-form video, one or more elements for providing a digital social response to the short-form video, a transcript of the short-form video, etc.

In examples in which social networking platform 208 provides a variety of services, social networking platform 208 may rely on information collected from one service of the platform to configure content for a user in another service of the platform. For example, as will be described in greater detail below, social networking platform 208 may rely on information collected across a variety of its services to configure a top-of-feed tray within a social media feed of one of its services (e.g., a newsfeed, stories feed, and/or short-form video feed).

Returning to FIG. 1, at step 110, one or more of the systems described herein may determine that a user of a social networking platform, which provides multiple digital services to its users, has accessed a digital service of the social networking platform less than a threshold amount. For example, as illustrated in FIG. 2, an optimization module 212 may determine that user 206 of social networking platform 208, which provides multiple digital services 214 to its users, has accessed a digital service 216 of social networking platform 208 less than a threshold amount. The threshold amount may be defined in a variety of ways. In some examples, the threshold amount may be a number. As a specific example, the threshold amount may be the number one (e.g., indicating that user 206 has never accessed digital service 216), ten, or any other number. In some examples, the threshold amount may have a time constraint (e.g., optimization module 212 may identify a digital service that user 206 has accessed less than a threshold amount within a specified time period).

Digital service 216 may represent any type or form of digital service provided by social networking platform 208 (e.g., via server 202). In some examples, digital service 216 may represent one of the services described above in connection with FIG. 2 (e.g., a short-form video service, a digital story service, a newsfeed service, and/or a digital messaging service). Additionally or alternatively, digital service 216 may represent a video room and/or audio room service (e.g., that enables videoconferencing and/or audioconferencing), a media streaming service (e.g., a watch feed), an audio feed service, and/or an augmented reality service.

In some examples, optimization module 212 may operate within server 202 and may determine user 206's access of digital service 216 based on access data received from user device 204. Additionally or alternatively, optimization module 212 may operate within user device 204 (e.g., as part of social media application 210) and may determine user 206's access of digital service 216 directly.

At step 120, one or more of the systems described herein may, in response to determining that the user has accessed the digital service less than the threshold amount, present a selectable tile, which serves as an entry point for the digital service, in a digital tray of entry point tiles provided via a social media feed configured for the user. For example, as illustrated in FIG. 2, optimization module 212 may, in response to determining that user 206 has accessed digital service 216 less than the threshold amount, present a selectable tile 218, which serves as an entry point for digital service 216, in a digital tray of entry point tiles 220 provided via a social media feed interface 222 configured for user 206.

Social media feed interface 222 generally represents any type or form of digital feed of social media posts. Social media feed interface 222 may correspond to the social media feed of any service provided by social networking platform 208. For example, social media feed interface 222 may correspond to a newsfeed or a stories feed. In some examples, social media feed interface 222 may present a scrollable (e.g., vertically scrollable) collection of social media posts (e.g., as depicted in FIG. 3 for embodiments in which social media feed interface 222 corresponds to a newsfeed). In some examples, social media feed interface 222 may also include a digital tray of entry point tiles (e.g., digital tray of entry point tiles 220).

Digital tray of entry point tiles 220 may generally refer to any type or form of visual structure within a graphical user interface that visually designates a set of digital entry point tiles. The term “digital entry point tile” generally refers to any type of form of selectable visual element, within a graphical user interface, that (1) corresponds to a particular digital service of social networking platform 208 and/or to particular content and/or a particular digital container maintained by a digital service of social networking platform 208 and (2) navigates to an interface of the particular digital service (e.g., a social media feed interface of the particular digital service) and/or to the particular content and/or content of the particular digital container when selected via user input. In some examples, social media feed interface 222 may present a social media feed of posts posted to a particular digital service of social networking platform 208 and digital tray of entry point tiles 220 may include selectable tiles corresponding to additional digital services (e.g., other than the particular digital service corresponding to the social media feed presented within social media feed interface 222). In some examples, as mentioned above, an entry point tile may correspond to a particular digital container and/or to particular content (e.g., a post) maintained by a digital service (e.g., by digital service 216). For example, an entry point tile may correspond to a digital container for posts designated for a user's birthday, a digital group page, an item posted to a marketplace service, and/or a digital container corresponding to content for an event. In some examples, an entry point tile may correspond to a mixed-content feed (e.g., that focuses on a topic) with content maintained by a variety of different services.

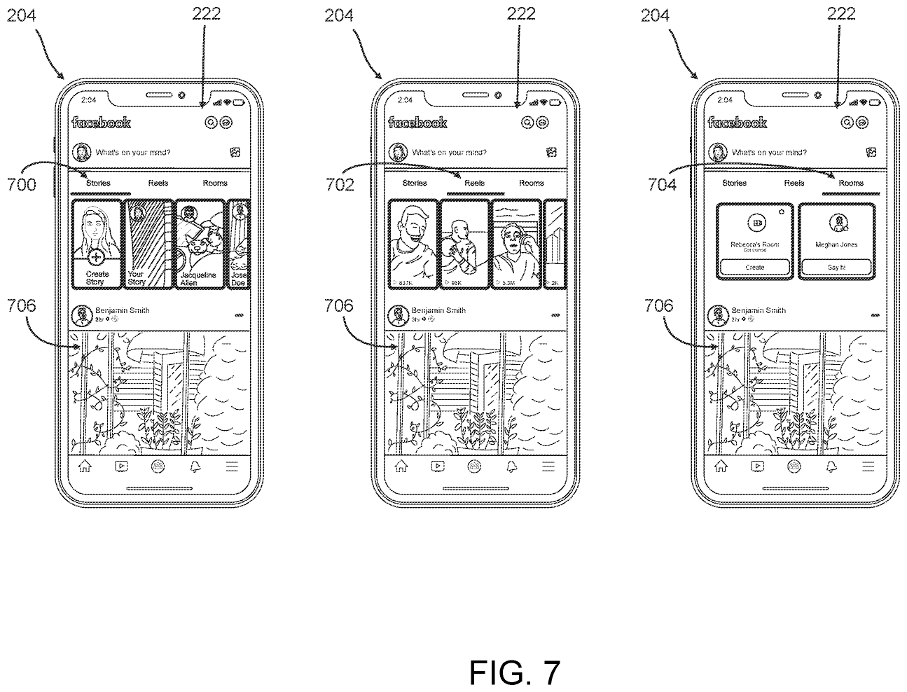

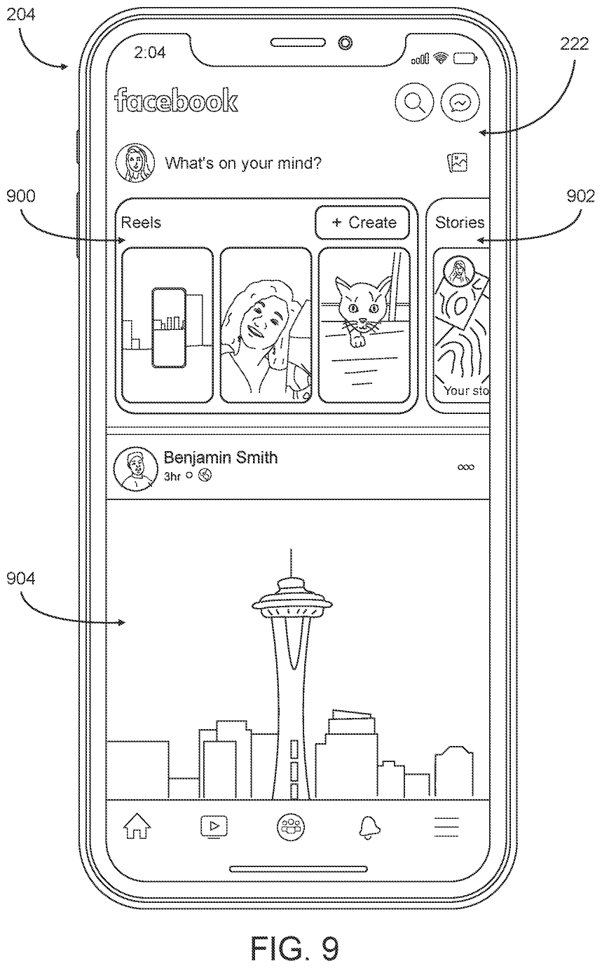

Digital tray of entry point tiles 220 may take any visual form. FIG. 7 depicts an embodiment in which digital tray of entry point tiles 220 includes (1) a set of selectable word-based elements, each corresponding to a different digital service (stories element 700, reels element 702, and rooms element 704 in FIG. 7), (2) a highlights bar (e.g., placed beneath one of the word-based elements, indicating which of the word-based elements is selected), and (3) a set of selectable entry point tiles, placed immediately beneath the word-based elements and highlights bar, corresponding to the digital service whose corresponding word-based element has been selected. In this embodiment, each entry point tile displayed when the word-based element for a particular digital service is selected may correspond to content of the particular digital service. Turning to FIG. 7 as a specific example, when stories element 700 is selected, the displayed entry point tiles may correspond to a story post accessible via a stories service and/or may correspond to a story creation flow. When reels element 702 is selected, the displayed entry point tiles may correspond to a short-form video accessible via a short-form video service and/or a short-form video creation flow. When rooms element 704 is selected, the entry point tiles may correspond to video rooms accessible to user 206 via a videoconferencing service. FIG. 9 depicts an embodiment in which digital tray of entry point tiles 220 includes a series of enclosed visual structures, each of which corresponds to a different digital service of social networking platform 208 and each of which includes tiles corresponding to its corresponding digital service (e.g., a first visual structure 900 corresponding to a short-form video service and a second visual structure 902 corresponding to a stories service).

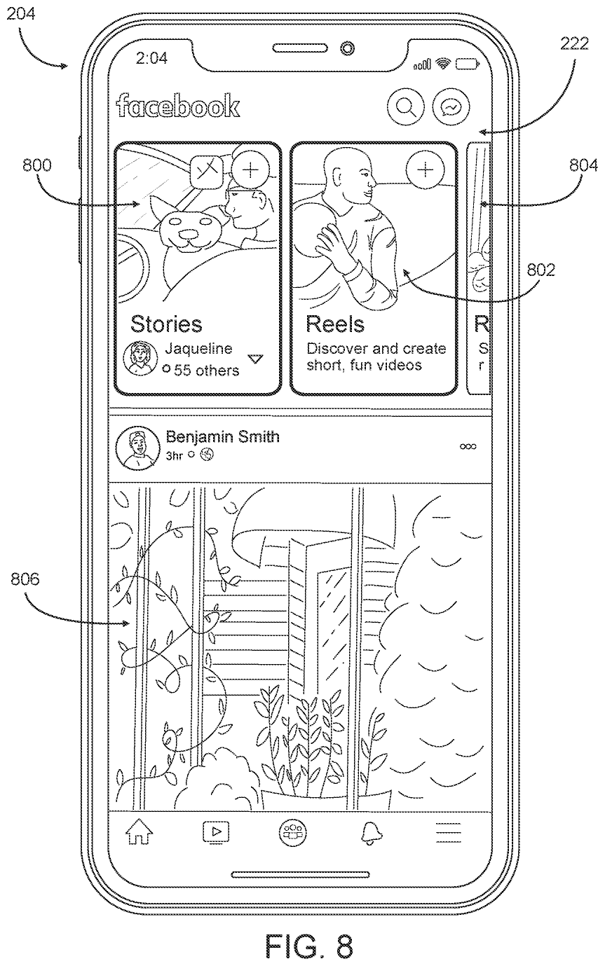

Digital tray of entry point tiles 220 may take any position within social media feed interface 222. In some examples, digital tray of entry point tiles 220 may be positioned above the social media posts of a social media feed presented within social media feed interface 222 (e.g., at the top of the social media feed as a top-of-feed tray). For example, FIGS. 7-9 each depict an embodiment in which social media feed interface 222 provides digital tray of entry point tiles 220 above a first social media post (e.g., post 706 in FIG. 7, post 806 in FIG. 8, and post 904 in FIG. 9) of the social media feed presented within social media feed interface 222.

In some embodiments, digital tray of entry point tiles 220 may include a scrollable carousel of selectable tiles, each tile corresponding to a different social media service and/or digitally consumable digital container of social networking platform 208. FIG. 8 depicts an embodiment in which social media feed interface 222 includes a scrollable carousel of selectable tiles (e.g., with tile 800, corresponding to a digital stories service, tile 802, corresponding to a short-form video service, and tile 804, corresponding to a videoconferencing service). In this embodiment, user scrolling input may reveal additional tiles for additional consumable services and/or digital containers (e.g., a digital watch service, a group page, a messaging service, etc.).

In response to receiving user input selecting selectable tile 218 from digital tray of entry point tiles 220, the disclosed systems and methods (e.g., via a navigation module) may present an interface corresponding to digital service 216. Turning to FIG. 9 as a specific example, the disclosed systems and methods may present a short-form video interface in response to receiving user input selecting an entry point tile from first visual structure 900 and/or a stories interface in response to receiving user input selecting an entry point tile from second visual structure 902. In some examples, the interface corresponding to digital service 216 may represent a social media feed corresponding to digital service 216. Additionally or alternatively, in examples in which the selected entry point tile corresponds to a specific post posted to digital service 216, the interface corresponding to digital service 216 may correspond specifically to the specific post. In examples in which the selected entry point tile corresponds to a creation process for creating a post for digital service 216, the interface corresponding to digital service 216 may correspond to the creation process.

The digital services represented within digital tray of entry point tiles 220 may be selected in a variety of ways. In some examples, as mentioned above, a digital service may be selected in response to determining that user 206 has accessed the digital service less than a threshold amount. By prioritizing digital services that a user has accessed less than a threshold amount (e.g., has never accessed, has not accessed in a designated amount of time, and/or has accessed less and/or less often than a threshold amount), the disclosed systems and methods may remind user 206 of a digital service that user 206 has not used recently and/or may introduce user 206 to new digital services of which user 206 may not have been aware.

In addition, or as an alternative, to selecting digital services that have been accessed by user 206 less than a threshold amount, optimization module 212 may select a digital service in response to determining that the digital service has been accessed more than an additional threshold amount. Additionally or alternatively, optimization module 212 may (1) predict (for user 206) a user interest in a digital service of social networking platform 208 (e.g., based on a usage history of the user and/or a demographic of the user) and, (2) select the digital service in response to the prediction. As another example, optimization module 212 may select a digital service based on contact information for the user. For example, optimization module 212 may select a digital service that provides a social media feed of non-connected content in response to predicting (for user 206) a user interest in the digital service based on determining (1) that user 206 has fewer than a threshold number of contacts and/or (2) that user 206 has less than a threshold amount of digital connection with user 206's contacts (e.g., that user 206 has digitally commented on content posted by user 206's contacts less than a threshold amount, has digitally messaged user 206's contacts less than the threshold amount, etc.).

In examples in which optimization module 212 operates within server 202, optimization module 212 may present selectable tile 218 by instructing user device 204 to present selectable 218. Additionally or alternatively, in examples in which optimization module 212 operates within user device 204 (e.g., as part of social media application 210), optimization module212 may present selectable 218 directly (e.g., via a display element of user device 204).

As described above, the disclosed systems and methods may enable dynamically selected entry point tiles to be displayed within an entry point tray of a social media feed. By dynamically selecting entry point tiles for an entry point tray, the disclosed systems and methods may organize data navigation in a way that provides a user with easy access to (1) content that the user frequently accesses, (2) content that the user may be unaware of and/or unfamiliar with, and/or (3) content that the user is predicted to be interested in.

### Example Embodiments

Example 1: A computer-implemented method may include (1) determining that a user of a social networking platform, which provides multiple digital services to its users, has accessed a digital service of the social networking platform less than a threshold amount and (2) in response to determining that the user has accessed the digital service less than the threshold amount, presenting a selectable tile, which serves as an entry point for the digital service, in a digital tray of entry point tiles provided via a social media feed configured for the user.

Example 2: The computer-implemented method of example 1, where (1) the social media feed includes a digital feed of social media posts and (2) the digital tray of entry point tiles is presented at the top of the social media feed, above the social media posts of the social media feed.

Example 3: The computer-implemented method of examples 1-2, where the computer-implemented method further includes (1) determining that the user of the social networking platform has accessed an additional digital service of the social networking platform more than an additional threshold amount and (2) in response to determining that the user has accessed the additional digital service more than the additional threshold amount, presenting an additional selectable tile, which serves as an entry point for the additional digital service, in the digital tray of entry point tiles.

Example 4: The computer-implemented method of example1 1-3, where the computer-implemented method further includes (1) predicting a user interest for the user in an additional digital service of the social networking platform based on a usage history of the user and/or a demographic of the user and (2) in response to predicting the user interest for the user in the additional digital service, presenting an additional selectable tile, which serves as an entry point for the additional digital service, in the digital tray of entry point tiles.

Example 5: The computer-implemented method of examples 1-4, where the computer-implemented method further includes (1) predicting a user interest for the user in an additional digital service of the social networking platform based on contact information for the user and (2) in response to predicting the user interest for the user in the additional digital service, presenting an additional selectable tile, which serves as an entry point for the additional digital service, in the digital tray of entry point tiles.

Example 6: The computer-implemented method of example 5, where (1) the additional digital service includes an additional social media feed that presents non-connected content and (2) predicting the user interest for the user in the additional digital service based on the contact information for the user includes determining (i) that the user has fewer than a threshold number of contacts and/or (ii) that the user has less than a threshold amount of digital connection with the user's contacts.

Example 7: The computer-implemented method of examples 1-6, where the digital service represents a short-form video service, a digital stories service, a digital newsfeed service, a video room service, a digital messaging service, a media streaming service, and/or audio feed service.

Example 8: The computer-implemented method of examples 1-7, where the computer-implemented method further includes (1) receiving user input selecting the selectable tile and (2) presenting an interface corresponding to the digital service in response to receiving the user input.

Example 9: The computer-implemented method of examples 1-8, where the social media feed represents a newsfeed and/or a stories feed.

Example 10: A system for implementing the above-described method may include at least one physical processor and physical memory that includes computer-executable instructions that, when executed by the physical processor, cause the physical processor to (1) determine that a user of a social networking platform, which provides a plurality of digital services to its users, has accessed a digital service of the social networking platform less than a threshold amount and (2) in response to determining that the user has accessed the digital service less than the threshold amount, present a selectable tile, which serves as an entry point for the digital service, in a digital tray of entry point tiles provided via a social media feed configured for the user.

Example 11: The system of example 10, where (1) the social media feed is a digital feed of social media posts and (2) the digital tray of entry point tiles is presented at the top of the social media feed, above the social media posts of the social media feed.

Example 12: the system of examples 10-11, where the computer-executable instructions further cause the physical processor to (1) determine that the user of the social networking platform has accessed an additional digital service of the social networking platform more than an additional threshold amount and (2) in response to determining that the user has accessed the additional digital service more than the additional threshold amount, present an additional selectable tile, comprising an entry point for the additional digital service, in the digital tray of entry point tiles.

Example 13: the system of examples 10-12, where the computer-executable instructions further cause the physical processor to (1) predict a user interest for the user in an additional digital service of the social networking platform based on a usage history of the user and/or a demographic of the user and (2) in response to predicting the user interest for the user in the additional digital service, present an additional selectable tile, which serves as an entry point for the additional digital service, in the digital tray of entry point tiles.

Example 14: The system of examples 10-13, where the computer-executable instructions further cause the physical processor to (1) predict a user interest for the user in an additional digital service of the social networking platform based on contact information for the user and (2) in response to predicting the user interest for the user in the additional digital service, present an additional selectable tile, which serves as an entry point for the additional digital service, in the digital tray of entry point tiles.

Example 15: The system of example 14, where (1) the additional digital service includes an additional social media feed that presents non-connected content and (2) predicting the user interest for the user in the additional digital service based on the contact information for the user includes determining (i) that the user has fewer than a threshold number of contacts and/or (ii) that the user has less than a threshold amount of digital connection with the user's contacts.

Example 16: The system of example 10-15, where the digital service represents a short-form video service, a digital stories service, a digital newsfeed service, a video room service, a digital messaging service, a media streaming service, and/or audio feed service.

Example 17: The system of examples 10-16, where the computer-executable instructions further cause the physical processor to (1) receive user input selecting the selectable tile and (2) present an interface corresponding to the digital service in response to receiving the user input.

Example 18: The system of examples 10-17, where the social media feed represents a newsfeed and/or a stories feed.

Example 19: A non-transitory computer-readable medium may include one or more computer-readable instructions that, when executed by at least one processor of a computing device, cause the computing device to (1) determine that a user of a social networking platform, which provides a plurality of digital services to its users, has accessed a digital service of the social networking platform less than a threshold amount and (2) in response to determining that the user has accessed the digital service less than the threshold amount, present a selectable tile, which serves as an entry point for the digital service, in a digital tray of entry point tiles provided via a social media feed configured for the user.

Example 20: The non-transitory computer-readable medium of example 19, where (1) the social media feed is a digital feed of social media posts and (2) the digital tray of entry point tiles is presented at the top of the social media feed, above the social media posts of the social media feed.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device (e.g., memory device 226 and 228 in FIG. 2) and at least one physical processor (e.g., physical processor 230 and 232 in FIG. 2).

The term “memory device” generally represents any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium” may refer to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
determining that a user of a social networking platform, which provides a plurality of digital services to its users, has accessed a digital service of the social networking platform less than a threshold amount; and
in response to determining that the user has accessed the digital service less than the threshold amount, presenting a selectable tile, comprising an entry point for the digital service, in a digital tray of entry point tiles provided via a social media feed configured for the user.

2. The computer-implemented method of claim 1, wherein:
the social media feed comprises a digital feed of social media posts; and
the digital tray of entry point tiles is presented at the top of the social media feed, above the social media posts of the social media feed.

3. The computer-implemented method of claim 1, further comprising:
determining that the user of the social networking platform has accessed an additional digital service of the social networking platform more than an additional threshold amount; and
in response to determining that the user has accessed the additional digital service more than the additional threshold amount, presenting an additional selectable tile, comprising an entry point for the additional digital service, in the digital tray of entry point tiles.

4. The computer-implemented method of claim 1, further comprising:
predicting a user interest for the user in an additional digital service of the social networking platform based on at least one of a usage history of the user or a demographic of the user; and
in response to predicting the user interest for the user in the additional digital service, presenting an additional selectable tile, comprising an entry point for the additional digital service, in the digital tray of entry point tiles.

5. The computer-implemented method of claim 1, further comprising:
predicting a user interest for the user in an additional digital service of the social networking platform based on contact information for the user; and
in response to predicting the user interest for the user in the additional digital service, presenting an additional selectable tile, comprising an entry point for the additional digital service, in the digital tray of entry point tiles.

6. The computer-implemented method of claim 5, wherein:
the additional digital service comprises an additional social media feed that presents non-connected content; and
predicting the user interest for the user in the additional digital service based on the contact information for the user comprises determining at least one of (1) that the user has fewer than a threshold number of contacts or (2) that the user has less than a threshold amount of digital connection with the user's contacts.

7. The computer-implemented method of claim 1, wherein the digital service comprises at least one of:
a short-form video service;
a digital stories service;
a digital newsfeed service;
a video room service;
a digital messaging service;
a media streaming service; or
an audio feed service.

8. The computer-implemented method of claim 1, further comprising:
receiving user input selecting the selectable tile; and
presenting an interface corresponding to the digital service in response to receiving the user input.

9. The computer-implemented method of claim 1, wherein the social media feed comprises at least one of:
a newsfeed; or
a stories feed.

10. A system comprising:
at least one physical processor;
physical memory comprising computer-executable instructions that, when executed by the physical processor, cause the physical processor to:
determine that a user of a social networking platform, which provides a plurality of digital services to its users, has accessed a digital service of the social networking platform less than a threshold amount; and
in response to determining that the user has accessed the digital service less than the threshold amount, present a selectable tile, comprising an entry point for the digital service, in a digital tray of entry point tiles provided via a social media feed configured for the user.

11. The system of claim 10, wherein:
the social media feed comprises a digital feed of social media posts; and
the digital tray of entry point tiles is presented at the top of the social media feed, above the social media posts of the social media feed.

12. The system of claim 10, wherein the computer-executable instructions further cause the physical processor to:
determine that the user of the social networking platform has accessed an additional digital service of the social networking platform more than an additional threshold amount; and
in response to determining that the user has accessed the additional digital service more than the additional threshold amount, present an additional selectable tile, comprising an entry point for the additional digital service, in the digital tray of entry point tiles.

13. The system of claim 10, wherein the computer-executable instructions further cause the physical processor to:
predict a user interest for the user in an additional digital service of the social networking platform based on at least one of a usage history of the user or a demographic of the user; and
in response to predicting the user interest for the user in the additional digital service, present an additional selectable tile, comprising an entry point for the additional digital service, in the digital tray of entry point tiles.

14. The system of claim 10, wherein the computer-executable instructions further cause the physical processor to:
predict a user interest for the user in an additional digital service of the social networking platform based on contact information for the user; and
in response to predicting the user interest for the user in the additional digital service, present an additional selectable tile, comprising an entry point for the additional digital service, in the digital tray of entry point tiles.

15. The system of claim 14, wherein:
the additional digital service comprises an additional social media feed that presents non-connected content; and
predicting the user interest for the user in the additional digital service based on the contact information for the user comprises determining at least one of (1) that the user has fewer than a threshold number of contacts or (2) that the user has less than a threshold amount of digital connection with the user's contacts.

16. The system of claim 10, wherein the digital service comprises at least one of:
a short-form video service;
a digital stories service;
a digital newsfeed service;
a video room service;
a digital messaging service;
a media streaming service; or
an audio feed service.

17. The system of claim 10, wherein the computer-executable instructions further cause the physical processor to:
receive user input selecting the selectable tile; and
present an interface corresponding to the digital service in response to receiving the user input.

18. The system of claim 10, wherein the social media feed comprises at least one of:
a newsfeed; or
a stories feed.

19. A non-transitory computer-readable medium comprising one or more computer-readable instructions that, when executed by at least one processor of a computing device, cause the computing device to:
determine that a user of a social networking platform, which provides a plurality of digital services to its users, has accessed a digital service of the social networking platform less than a threshold amount; and
in response to determining that the user has accessed the digital service less than the threshold amount, present a selectable tile, comprising an entry point for the digital service, in a digital tray of entry point tiles provided via a social media feed configured for the user.

20. The non-transitory computer-readable medium of claim 19, wherein:
the social media feed comprises a digital feed of social media posts; and
the digital tray of entry point tiles is presented at the top of the social media feed, above the social media posts of the social media feed.
